(19) United States
(12) Patent Application Publication
(10) Pub. No.: US 2008/0180451 A1
(43) Pub. Date: Jul. 31, 2008

(54) DISPLAY CONTROLLER, ELECTRONIC APPLIANCE, AND METHOD OF PROVIDING IMAGE DATA

(75) Inventor: Atsushi OBINATA, Hachioji (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/928,119

(22) Filed: Oct. 30, 2007

Related U.S. Application Data
(62) Division of application No. 11/153,291, filed on Jun. 15, 2005.

(30) Foreign Application Priority Data
Jun. 25, 2004 (JP) 2004-188491

(51) Int. Cl. G06T 1/60

(52) U.S. Cl. 345/530

(57) ABSTRACT

A display controller includes: a first memory that stores multiple frames of the image data; a second memory having a smaller storage capacity than that of the first memory, storing at least one frame of the image data; and a memory data switching circuit that outputs, either the image data read out from the first memory, the image data read out from the second memory, or the mixed data wherein the image data for single scanning read out from the first memory and the image data read out from the second memory are mixed. The display controller provides to the display driver, either the image data read out from the first memory, the image data red out from the second memory, or the mixed data.

### CROSS-REFERENCE TO RELATED APPLICATIONS

This application is a divisional of U.S. patent application Ser. No. 11/153,291 filed on Jun. 15, 2005, which claims the benefit of Japanese Patent Application No. 2004-188491 filed Jun. 25, 2004. The disclosures of the above applications are incorporated herein by reference.

### BACKGROUND

1. Technical Field

The present invention relates to a display controller, an electronic appliance, and a method of providing image data.

2. Related Art

In recent years, display panels, typically Liquid Crystal Display (LCD) panels are commonly mounted on mobile appliances (or in a broader sense, electronic appliances), such as mobile phones and the like. A display panel is driven, based on image data, by a display driver. The image data may be imported from a camera module for example, or may be generated or processed by a host. The display driver controls the display panel upon receiving such image data as well as a display synchronization signal.

The display controller conducts the provision of the image data as well as the display synchronization signals on behalf of the host, so that the processing load of the host can be diminished. Among such display controllers, some have a built-in memory that functions as a video memory, in order to achieve a lower power-consumption.

There is a strong requirement, that display controllers which are mounted on mobile appliances, operate with a low power consumption. For this reason, a memory built into a display controller is equipped with a Static Random Access Memory (SRAM), which consumes less power than a Dynamic Random Access Memory (DRAM). This has restricted the capacity of the memory built into the display controller to be relatively small, yet it has been possible to get by with a small memory capacity, since the display size of an LCD panel has been small. It has also allowed reducing the size of a chip on the display controller. Therefore, this structure had advantages in cost as well as in packaging.

However, in recent years, there has been an increasing demand for the size of LCD panel displays, to have a QVGA size (at least 240 by 320 pixels). As the display size grows, the size of the image data increases. This results in a longer transfer times for transferring the image data from a host to a display controller, as well as from a display controller to a display driver. This causes a distinctive flickering of images being refreshed in a prescribed cycle at LCD panels, or results in a complex read out control of the image data from the video memory. The symptom becomes more prominent when rewriting the image data of still images in a series, or when rewriting that of the video image.

Moreover, since the host cannot handle other processing during the data transfer, it results in a lower performance in the entire system.

Furthermore, even though the disadvantages in the aspect of packaging have been pointed out if the chip size grows larger along with the capacity of the memory that needs to be built in, it is no longer the situation, when the packaging technology is advancing in recent years. The display controllers with built-in SRAM as a memory do not necessarily have an advantage in terms of packaging.

In light of the above-mentioned technical challenge, the advantage of the present invention is to provide a display controller, an electronic appliance, and a method of providing image data, where the degradation of system performance as well as the deterioration in image quality are suppressed.

### SUMMARY

According to a first aspect of the invention, a display controller for providing an image data to a display driver that drives a display panel, includes: a first memory that stores multiple frames of the image data; a second memory having a smaller storage capacity than that of the first memory, storing at least one frame of the image data; and a memory data switching circuit that outputs, either the image data read out from the first memory, the image data read out from the second memory, or the mixed data wherein the image data for single scanning read out from the first memory and the image data read out from the second memory are mixed; wherein either the image data read out from the first memory, the image data red out from the second memory, or the mixed data is provided to the display driver.

In the invention, while multiple frames of image data of a large size, such as video data, are stored in a first memory, at least one frame of image data of a small data size, such as still image data, can be stored in a second memory. As a result, compared to the case where the image data of a large size is stored in the second memory, the increase in refresh frequency of the storage content thereof can be avoided, and thus the write-in frequencies of the image data to the first memory can be decreased. Therefore, when the host provides the image data to the first memory, the transfer processing load of this host can be decreased, and the system performance degradation of the display controller as well as that of the host, can be suppressed.

In the display controller of the invention, the memory data switching circuit may refresh the setting of a display area of each image data that is from the image data of the first and the second memory, during the non-display period specified by a vertical synchronization signal. It may also output the mixed data to display, during the subsequent display period after the non-display period.

Moreover, in the display controller in the invention includes a memory selection register, wherein a control information for specifying from where among the first and the second memory, the image data is read out. Further, the memory data switching circuit, which, after sequentially reading out the image data, from one of either the first or the second memory that is in accordance with the control information in the memory selection register, may sequentially read out the image data from the other memory to display during a display period of the display area of the image data from the other memory, and may output the mixed data.

With the present invention, the image data switching during the display period can be avoided, and the image flickering can be credibly prevented.

In the display controller in the invention, the image data stored in the first memory may be a video data; and the image data stored in the second memory may be a still image data.

With the present invention, multiple frames of video data can be written in to the first memory. Hence it is possible to prevent the deterioration in the video image quality that is caused by the delay of the write-in processing of the video data, as well as to attain smooth video display.

In the display controller in the invention, the first memory may be a Dynamic Random Access Memory (DRAM); and the second memory may be a Static Random Access Memory (SRAM).

In the present invention, at least one frame of image data can be stored in the Static Random Access Memory. Thus, if the storage capacity of the Static Random Access Memory is sufficient, it is possible to attain a lower power-consumption, since the amount of current that is consumed during the access time for providing the data to the display driver is small. For example, in case where the still image data is provided to the display driver that does not have a built-in display memory, repetitive access to the Static Random Access Memory in a prescribed display cycle is required. In such a case, the present invention provides a better effect in lowering the power-consumption mentioned above.

In the display controller in the invention may further include a stacked type semiconductor device, wherein a first chip formed including the dynamic random access memory, as well as a second chip formed including the static random access memory and the memory data switching circuit, are laminated.

With the present invention, even if the first memory has a large capacity, it is possible to package the memory with electronic appliances that have small packaging space. Here, in terms of packaging, there is no disadvantage compared to a display controller with only a small-sized chip memory built into it. Rather, it is still possible to gain the positive effect of mounting the large capacity first memory.

Further, the invention relates to an electronic appliance, that includes the display panel, the display controller according to the above, and the display driver that drives the display panel, based on the image data provided by the display controller.

Moreover, the electronic appliance in the invention may include a host that conducts the input and output of the image, to and from the display controller.

With the present invention, it is possible to provide an electronic appliance where the degradation of system performance as well as the deterioration in image quality is suppressed.

According to a second aspect of invention, a method of providing an image data, so as to provide the image data to a display driver that drives a display panel, the method includes: a storing of multiple frames of image data in a Dynamic Random Access Memory (DRAM), as well as a storing of at least one frame of image data in a Static Random Access Memory (SRAM); and a provision of the image data read out from the dynamic random access memory, the image data read out from the static random access memory, or a mixed image data for single scanning wherein the image data read out from the dynamic random access memory as well as the image data read out from the static random access memory are mixed, to the display driver.

The method of providing the image data in the invention, may further include: an refreshing of a setting for a display area of each image data from both the dynamic random access memory and the static random access memory, during a non-display period specified by a vertical synchronization signal; and an outputting of the mixed data to display, during the subsequent display period after the non-display period.

The method of providing the image data in the invention, may further include: a sequential reading out of an image data, from either the dynamic random access memory or the static random access memory, that is in accordance with a control information of a memory selection register that specifies from where the image data is read out, among the dynamic random access memory and the static random access memory; and a sequential reading out, from the other memory, of the image data to display, during the display period of the display area for the image data from the other memory, and an outputting of the mixed data.

In the method of providing the image data of the invention, the image data stored in the dynamic random access memory may be a video data; and the image data stored in the static random access memory may be a static image data.

### BRIEF DESCRIPTION OF THE DRAWINGS

FIG. 1 is a block diagram of an example structure of a display system, wherein the display controller in the embodiment is applied.

FIG. 2 is a block diagram of an example structure of the display controller in the embodiment.

FIG. 3 is a block diagram of an example structure of the display controller in the comparative example of the embodiment.

FIG. 4 is an explanatory drawing of the mixed data in the embodiment.

FIG. 5 is an explanatory drawing of the operation of the display controller in the embodiment.

FIG. 6 is another explanatory drawing of the operation of the display controller in the embodiment.

FIG. 7 is a block diagram of the example structure of the control register in FIG. 2.

FIG. 8 is a block diagram of the example structure of the RAM data switching circuit and the synchronization signal generation circuit in FIG. 2.

FIG. 9 is an explanatory drawing of the synchronization signals.

FIG. 10 is a block diagram of the example structure of the DRAM controller in FIGS. 2 and 8.

FIG. 11 is a block diagram of the example structure of the SRAM controller in FIGS. 2 and 8.

FIG. 12 is a block diagram of the example structure of the DRAM data image size reduction circuit in FIG. 8.

FIG. 13 is a block diagram of the example structure of the horizontal direction skipping circuit in FIG. 12.

FIG. 14 is an explanatory drawing of the horizontal direction reduction ratio in FIG. 13.

FIG. 15 is a timing chart of the operation example of the horizontal direction skipping circuit in FIG. 13.

FIG. 16 is another explanatory drawing of the display controller in the embodiment.

FIG. 17 is a sequence chart of an operation example of the display system in FIG. 1.

FIG. 18 is a block diagram of an example structure of the electronic appliance in the embodiment.

### DETAILED DESCRIPTION

The embodiments of the present invention will now be described in detail using drawings. The embodiments described hereafter shall not unreasonably limit the content of the invention referred to in Claims. Moreover, it does not necessarily mean that all of the structures described below are an essential requirement.

Display System

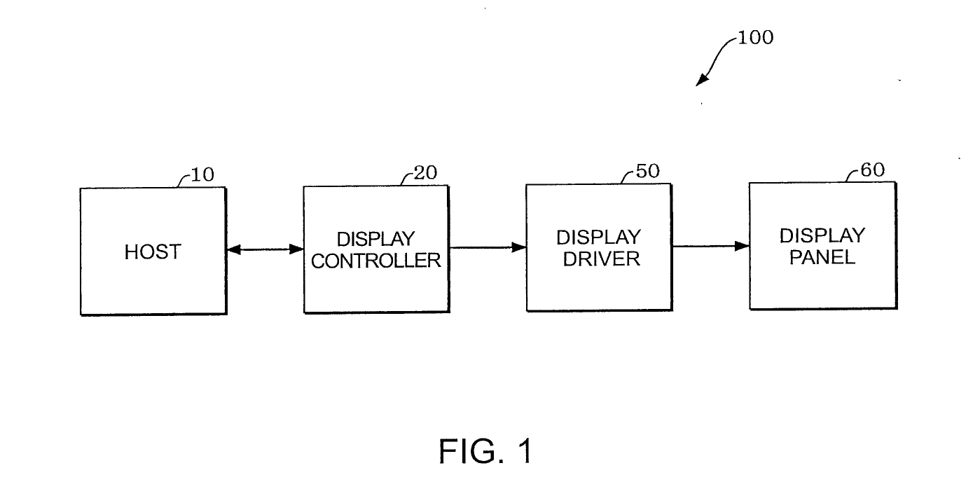

In FIG. 1, an example structure of a display system, wherein the display controller in the embodiment is applied, is shown. For example, the display system shown in FIG. 1 is mounted on electronic appliances.

A display system 100 includes a host 10, a display controller 20, a display driver 50, and a display panel 60. The host 10 has a Central Processing Unit (CPU) and a memory, and achieves a prescribed function by having the CPU, that reads in a program stored in the memory, execute a process compliant to the program. Here, the host 10 generates or processes the image data that corresponds to the image that is displayed in the display panel 60, and provides the data to the display controller 20.

The display controller 20 provides the image data from the host 10 to the display driver 50 that drives the display panel 60. The display controller 20 can provide video data, still image data, or mixed data wherein the video data and the still image data are mixed, generated by the host 10 to the display driver 50. The display controller 20 can conduct the process to generate this mixed data. The video data, the still image data, and the mixed data are referred to, in a broader sense, the image data.

The display driver 50 can drive the display panel 60, based on the image data from the display controller 20. An LCD panel, for example, of either active matrix type or passive matrix type can be employed in the display panel 60.

As described, the processing load of the host 10 can be diminished by the display controller 20 that is installed between the host 10 and the display driver 50, which conducts, for example, the image data processing on behalf of the host 10.

Display Controller

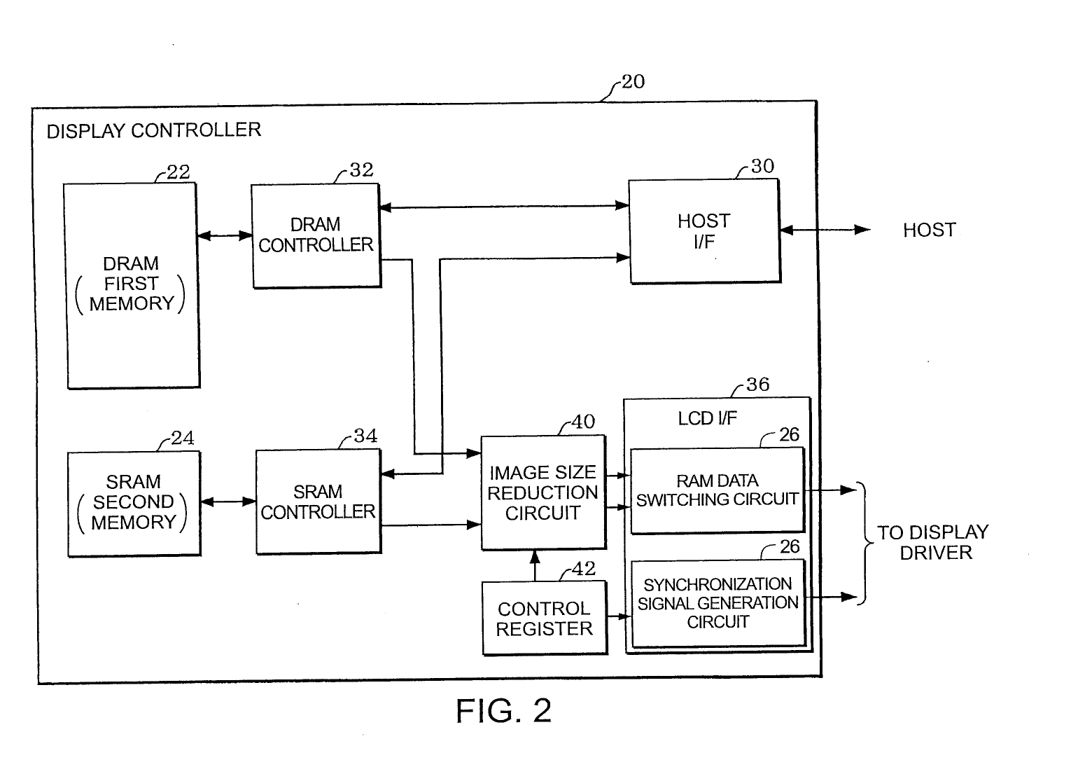

In FIG. 2, a block diagram of an example structure of the display controller 20 in the embodiment, is shown.

The display controller 20 includes a DRAM 22 (the first memory), and an SRAM 24 (the second memory). The DRAM 22 stores the multiple frames of image data. One frame of image data is equivalent to the image data scanned in one vertical scanning period. It is desirable that the video data be stored in the DRAM 22, although the still image data or the video data can also be stored there. The SRAM 24 has a smaller storage capacity than that of the DRAM 22, and stores at least one frame of image data. It is desirable that the still image data be stored in the SRAM 24, although the still image data or the video data can also be stored there.

Here, the DRAM 22 has a larger power consumption compared to the SRAM 24 during the access (read-out or write-in) time. This means that the DRAM 22 has a larger storage capacity than the SRAM 24. On the other hand, although the SRAM 24 has a smaller storage capacity than that of the DRAM 22, it has a smaller power consumption compared to the DRAM 22 during the access (read-out or write-in) time.

The display controller 20 includes a RAM data switching circuit (memory data switching circuit) 26. The RAM data switching circuit 26 outputs, either image data read out from the DRAM 22 (DRAM data), image data read out from the SRAM 24 (SRAM data), or image data from a single scanning (image data scanned in either one vertical scanning period or one horizontal scanning period), wherein the DRAM data and the SRAM data are mixed. The display controller 20 provides either the DRAM data, the SRAM data or the mixed data as the image data to the display driver 50.

Moreover, the display controller 20 includes a host interface (InterFace, hereafter I/F) circuit 30 (in a broader sense, the host interface), a DRAM controller 32, an SRAM controller 43, and an LCD I/F circuit 36 (in a broader sense, a display driver interface). The image data that is input from the host 10 via the host I/F circuit 30 is written in, either to the DRAM 22 by the DRAM controller 32, or to the SRAM 24 by the SRAM controller 34.

The image data (the video data or the still image data) from the host 10 is input to the host I/F circuit 30. Here, the host I/F circuit 30 conducts an interface processing, in other words, it conducts a receive process with the host or a signal buffering. Then, it provides the post interface processing image data either to the DRAM controller 32 or to the SRAM controller 34. Moreover, either the image data read out from the DRAM 22 by the DRAM controller 32, or the image data read out from the SRAM 24 by the SRAM controller 34, can be provided to the host 10 via the host I/F circuit 30. In this case, the host I/F circuit 30 conducts an interface processing. In other words, it conducts a send process with the host or a signal buffering. Then, it provides the post interface processing image data to the host 10.

The DRAM controller 32 conducts controls, such as specifying the write address of the DRAM 22 and writing the image data from the host 10, or specifying the read address of the DRAM 22 and reading out the image data from the DRAM 22.

The SRAM controller 34 controls, either the specifying of the write address of the SRAM 24 and the writing in of the image data from the host 10, or the specifying of the read address of the SRAM 24 and the reading out of the image data from the SRAM 24.

The LCD I/F circuit 36 outputs the image data read out from either the DRAM 22 or the SRAM 24 to the display driver 50. The LCD I/F circuit 36 conducts an interface processing of the image data. In other words, it conducts a send process with the display driver or a signal buffering. Then, it outputs the post interface processing image data to the display driver 50. The LCD I/F circuit 36 includes a synchronization signal-generation circuit 38, and generates synchronization signals for driving the display panel 60 (a vertical synchronization signal VSYNC, a horizontal synchronization signal HSYNC, a dot clock DCLK, etc.). It also outputs those synchronization signals to the display driver 50.

The display controller 20 can further include an image size reduction circuit 40. The image size reduction circuit 40 conducts a process to reduce the image size of the image data (DRAM data) read out from the DRAM 22. Moreover, the image size reduction circuit 40 conducts a process to reduce the image size of the image data (SRAM data) read out from the SRAM 24. The RAM data switching circuit 26 can output either the DRAM data or the SRAM data, whose sizes are reduced by the image size reduction circuit 40, to the display driver 50. Furthermore, the RAM data switching circuit 26 can generate mixed data to display in a window image, where one display area for one image data is created within another display area for other image data, using the DRAM data and the SRAM data, whose sizes are reduced by the image size reduction circuit 40.

The display controller 20 can furthermore include a control register 42. The host 10 can set control data (control information) to the control register 42 through the host I/F circuit 30. The control part (not shown) in the display driver 20 is responsible for controlling each part of the display controller 20, based on the control data of the control register 42.

Hereafter, the embodiment is described in contrast with the comparative example thereof.

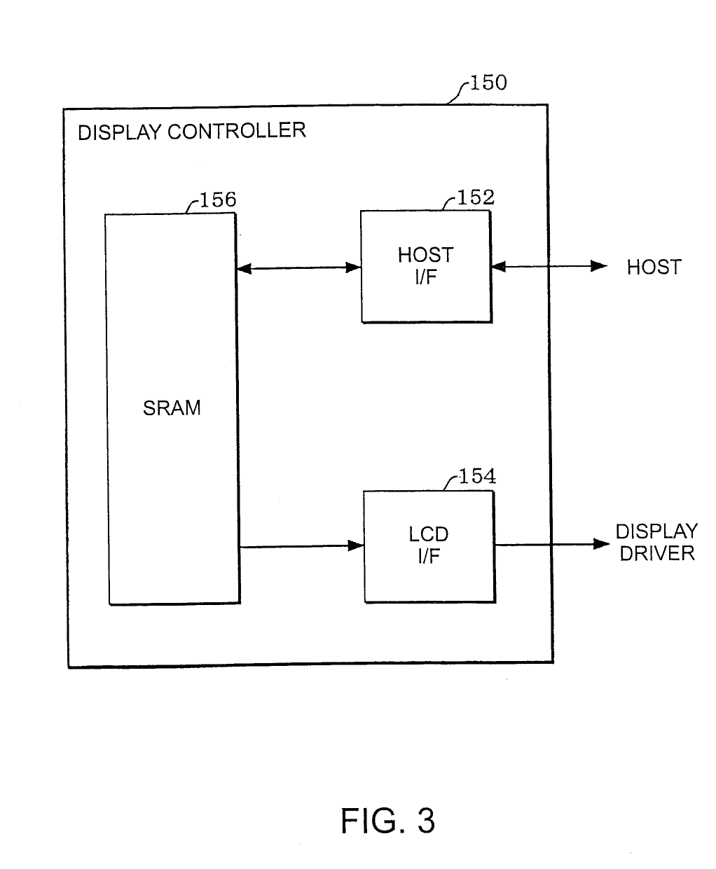

In FIG. 3, a block diagram of a schematic structure of the display controller in the comparative example of the embodiment is shown.

A display controller 150 in the comparative example includes a host I/F circuit 152, an LCD I/F circuit 154, and an SRAM 156. In the display controller 150, the image data from the host is stored via the host I/F circuit 152. Then, the display controller 150 provides the image data read out from the SRAM 156 to the display driver via the LCD I/F circuit 154. With the display controller 150 described above, it is possible to lower the power consumption since the SRAM 156 requires a lower power consumption during the access time compared to the DRAM.

However, the storage capacity of the SRAM 156 of the display controller 150 in the comparative example is not sufficient for storing video data. Because of this, when storing video data in the SRAM 156, there is a need for repetitive write-ins of video data from the host to the SRAM 156. Hence, the video data write-in processing (transfer processing) load of the host increases, and the delay in the write-in processing of the video data provokes a deterioration in the video image quality.

On the other hand, in the embodiment, the access frequency from the host is cut back by storing the multiple frames of video data to the DRAM 22. This way, it is possible to decrease the video data write-in processing (transfer processing) load of the host. Moreover, multiple frames of video data can be written in to the DRAM 22. Hence it is possible to prevent the deterioration in the video image quality that is caused by the delay in the write-in processing of the video data, as well as to attain a smooth video display.

The display controller 20 in the embodiment can further store at least one frame (for example, one frame or two frames) of still image data in the SRAM 24. Since the data size of the still image data is smaller than that of the video data, the storage capacity of the SRAM 24 is sufficient. It is therefore possible to attain a lower power-consumption, since the amount of current, consumed during the access time for providing the data to the display driver, is small. For example, in case where the still image data is provided to the display driver that does not have a built-in display memory, repetitive access to the SRAM 24 in a prescribed display cycle is required. Thus, with the embodiment, the effect of lowering the power-consumption is prominent.

The display controller 20 can provide the mixed data, generated for video display using the image data from the DRAM 22, and for still image display using the data from the SRAM 24, to the display driver.

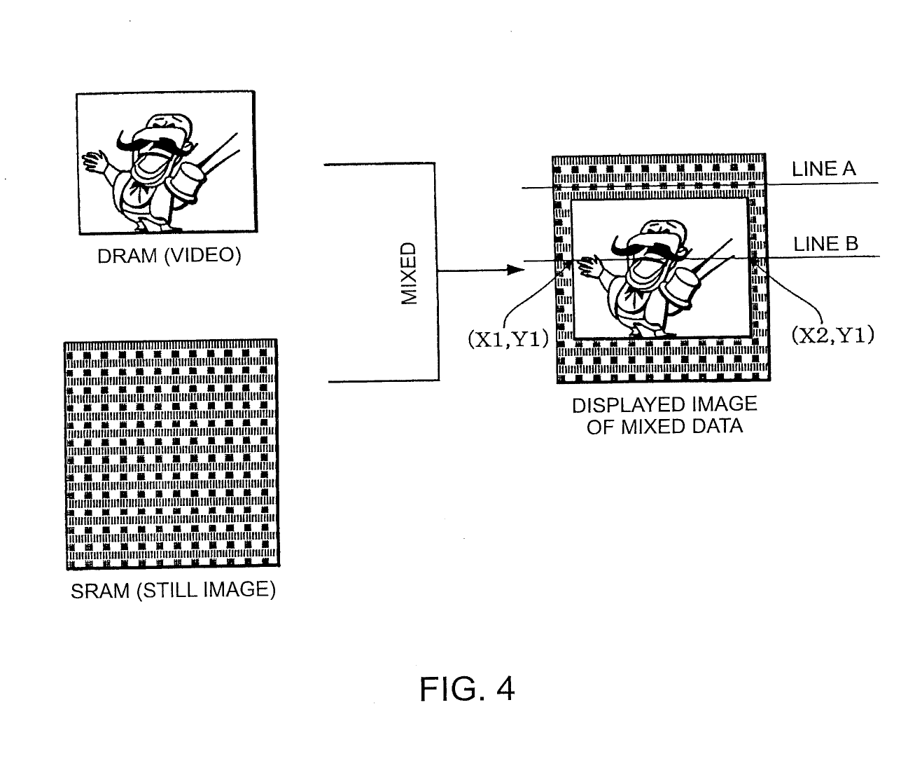

In FIG. 4, an explanatory drawing of the mixed data in the embodiment is shown. In FIG. 4, the case where the video display area is set within the still image display area is shown.

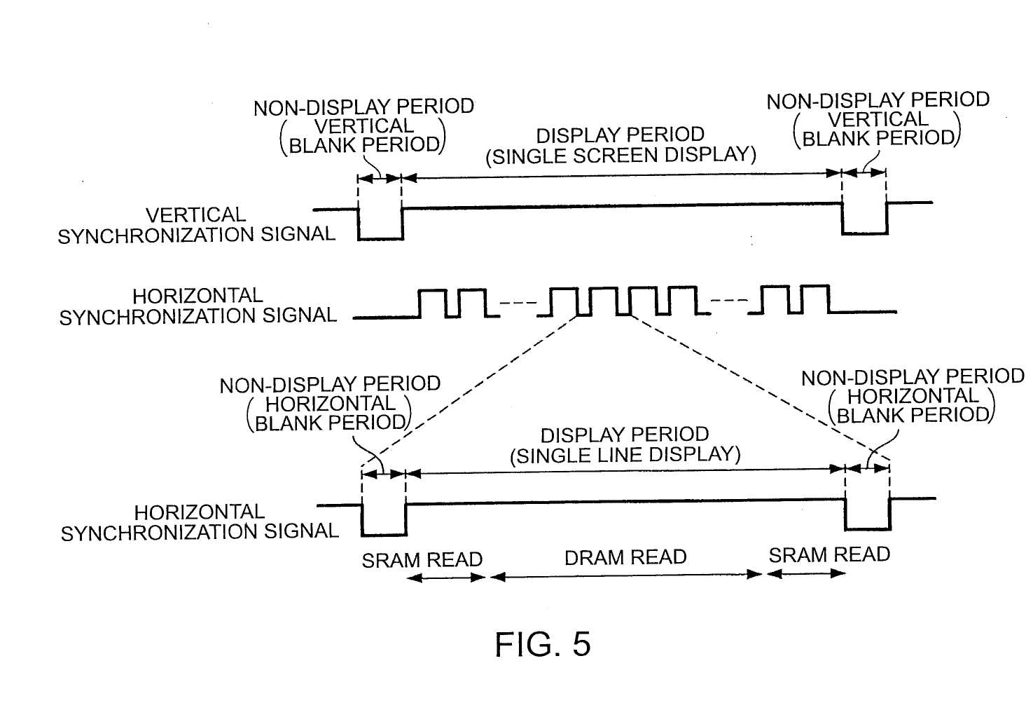

In FIG. 5, a timing chart in the operation example for the read-out timing of the DRAM 22 and the SRAM 24 for outputting the mixed data shown in FIG. 4, is shown.

For example, in case the still image display area and the video display area are set within the prescribed display area as a rectangular area, pixel locations on the diagonal line in each rectangular area are set in pairs. Then, in the scanning period of FIG. 4 line A, the image data is read out only from the SRAM 24, and the image data that is read out is provided to the display driver. In the scanning period of FIG. 4 line B, the image data is read out only from the SRAM 24 until the display pixel location reaches (X1, Y1), that is, SRAM-read in FIG. 5. When the display pixel location reaches (X1, Y1), the image data is read out only from the DRAM 22 (DRAM-read in FIG. 5). Then, when the display pixel location reaches (X2, Y1), the image data is read out only from the SRAM 24 again (SRAM-read in FIG. 5). The RAM data switching circuit 26 outputs the image data that is sequentially read out as above, as the mixed data. In FIGS. 4 and 5, a case where the video display area is set within the still image display area is explained, while in a case where the still image display area is set within the video display area, the same description applies, only the other way around.

It is desirable to halt the read-out operation from the DRAM 22 during the period when the SRAM data is read out. During the period when the DRAM data is read out, it is desirable to halt the read out operation from the SRAM 24. By operating only either one of the read-outs, power consumption can be decreased.

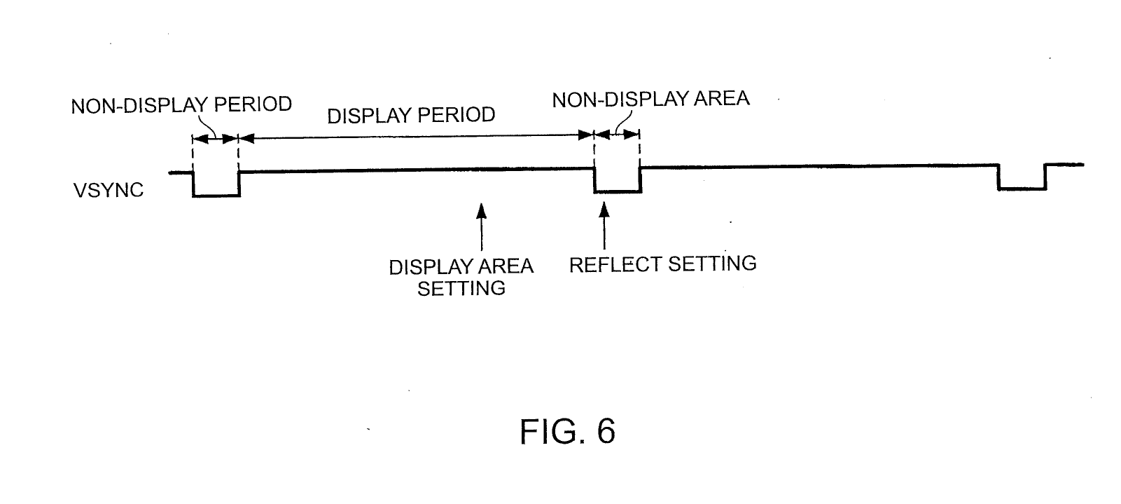

Moreover, if the prescribed display area is refreshed with the setting of the still image display area as well as the video display area, it is desirable that it be conducted during the so-called “non-display period”, as shown in FIG. 6. Moreover, after the refresh during the non-display period, it is desirable that the mixed data, displayed during the subsequent display period after the non-display period, is output. The non-display period is specified by the vertical synchronization signal VSYNC for display that is provided to the display driver 50. Therefore, this non-display period is equivalent to a vertical blank period. If the display period is set to the time when the vertical synchronization signal VSYNC is at level H, then the non-display period can be set to the time when the vertical synchronization signal VSYNC is at level L. Consequently, no image disturbance will occur during the display period (one screen display or one line display) shown in FIG. 5, and the deterioration in the image quality can be prevented.

Hereafter, a detailed example of the structure of the display controller 20 in the embodiment is described.

First, an example structure of the control register 42 in the display controller 20 in FIG. 2 will be described.

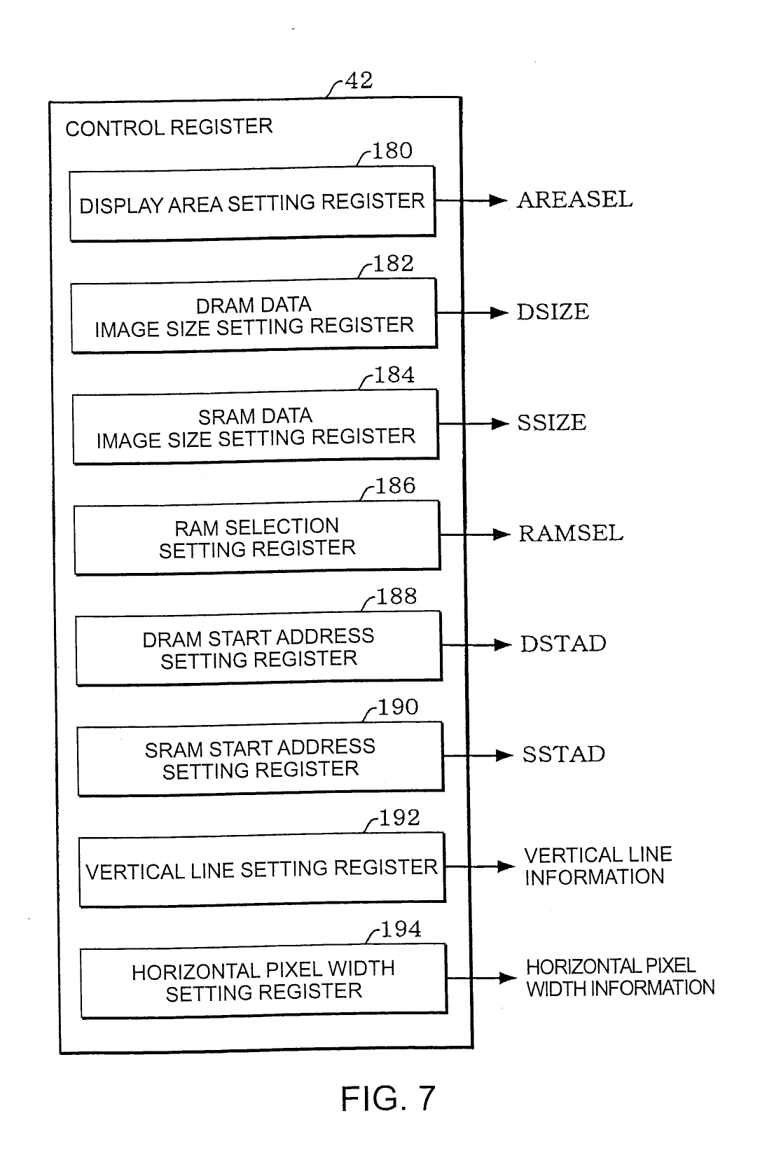

In FIG. 7, an example structure of the control register 42 in the display controller 20 in FIG. 2, is shown. The control information is set in each component of the control register 42 by the host through the host I/F circuit 30.

In a display area setting register 180, control information for setting the display area for the DRAM data as well as for the SRAM data is set. The control information set in the display area setting register 180 is output as a display area setting information AREASEL. The RAM data switching circuit 26 outputs the mixed data shown in FIGS. 4 and 5, using this display area setting information AREASEL.

In a DRAM data image size setting register 182, control information for setting the image size of the DRAM data is set. The control information set in the DRAM data image size setting register 182, is output as a DRAM data size information DSIZE. The image size reduction circuit 40 conducts a process to reduce the image size of the DRAM data by using the DRAM data size information DSIZE.

In an SRAM data image size setting register 184, control information for setting the image size of the SRAM data is set. The control information set in the SRAM data image size setting register 184, is output as an SRAM data size information SSIZE. The image size reduction circuit 40 conducts a process to reduce the image size of the SRAM data by using the SRAM data size information SSIZE.

In a RAM selection setting register 186, control information is set in order to specify whether to display the image of the DRAM data or to display the image of the SRAM data, in each display area that is set by the display area setting register 180. The control information set in the RAM selection setting register 186 is output as a RAM selection setting information RAMSEL. The RAM data switching circuit 26 outputs the mixed data shown in FIGS. 4 and 5, using this RAM selection setting information RAMSEL.

In a DRAM start address setting register 188, a read-start address of the DRAM data is set. The address set in the DRAM start address setting register 188 is output as a DRAM start address DSTAD. The DRAM controller 32 reads out the DRAM data from the DRAM 22, using the read address that is refreshed based on the DRAM start address DSTAD.

In an SRAM start address setting register 190, a read-start address of the SRAM data is set. The address set in the SRAM start address setting register 190 is output as an SRAM start address SSTAD. The SRAM controller 34 reads out the SRAM data from the SRAM 24, using the read address that is refreshed based on the SRAM start address SSTAD.

In a vertical line setting register 192, a control information for specifying the number of vertical lines in the display area of the display panel 60 is set. The control information set in the vertical line setting register 192 is output as a vertical line information.

In a horizontal pixel width setting register 194, a control information for specifying the number of pixels in the horizontal direction in the display area of the display panel 60 is set. The control information set in the horizontal pixel width setting register 194 is output as a horizontal pixel width information. The synchronization signal-generation circuit 38 uses the vertical line information and horizontal pixel width information, and generates synchronization signals for display in order to drive the display panel 60, such as the vertical synchronization signal VSYNC and the horizontal synchronization signal HSYNC, etc.

The various control information, set in the control register 42 in FIG. 7, is output to the RAM data switching circuit 26 as well as to the synchronization signal-generation circuit 38 in FIG. 2.

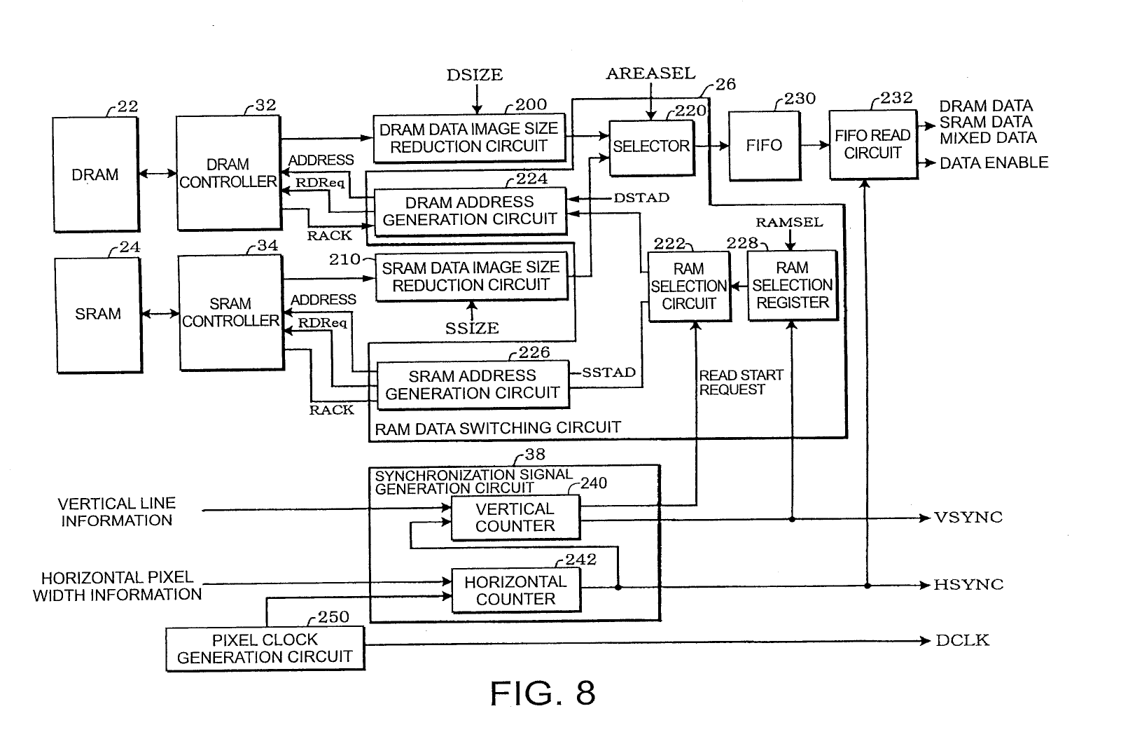

In FIG. 8, an example structure of the RAM data switching circuit 26 as well as that of the synchronization signal-generation circuit 38 in FIG. 2 is shown. In FIG. 2, the RAM data switching circuit 26 and the synchronization signal-generation circuit 38 are included in the LCD I/F circuit 36. However, the embodiment shall not be limited to this structure. Moreover, in FIG. 8, the connection between the RAM data switching circuit 26 and the synchronization signal-generation circuit 38, as well as the connection between, the DRAM controller 32, the SRAM controller 34, and the image size reduction circuit 40, are schematically shown.

In FIG. 8, a DRAM data image size reduction circuit 200, as well as an SRAM data image size reduction circuit 210, attain the function of the image size reduction circuit 40 in FIG. 2. The DRAM data image size reduction circuit 200 conducts a process to reduce the image size of the DRAM data, by using the DRAM data size information DSIZE from the control register 42. The SRAM data image size reduction circuit 210 conducts a process to reduce the image size of the SRAM data, by using the SRAM data size information SSIZE from the control register 42.

The RAM data switching circuit 26 includes an elector 220, a RAM selection circuit 222, a DRAM address generation circuit 224, an SRAM address generation circuit 226, and a RAM selection register 228 (a memory selection register).

The selector 220 outputs, either the image data (DRAM data) after the reduction processing by the DRAM data image size reduction circuit 200, or the image data (SRAM data) after the reduction processing by the SRAM data image size reduction circuit 210, based on the display area setting information AREASEL from the control register 42. Consequently, the selector 220 can output the DRAM data, SRAM data, and the mixed data wherein the DRAM data and the SRAM data are mixed. Therefore, image data such as the display image shown in FIG. 4 can be output.

The RAM selection switching circuit 222 starts the read-out operation of either the DRAM address generation circuit 224, or the SRAM address generation circuit 226, in accordance with the set value of the RAM selection register 228. The start timing of the read-out operation in the RAM selection circuit 222 is provided by the read-start request from the synchronization signal-generation circuit 38. For example, the read-start request can be generated, at a time before a certain period from the variant point of the vertical synchronization signal VSYNC, where that period is in accordance with the access timings of the DRAM 22 or the SRAM 24.

The set value of the RAM selection setting register 228 is refreshed, in synchronization with the vertical synchronization signal VSYNC from the synchronization signal-generation circuit 38, and set to the value of the RAM selection setting information RAMSEL. More specifically, the set value of the RAM selection setting register 228 is refreshed, in synchronization with the vertical synchronization signal VSYNC provided from the synchronization signal-generation circuit 38, and set to the value of the RAM selection setting information RAMSEL during the non-display period specified from this vertical synchronization signal VSYNC. Hence, the switching between the DRAM 22 and the SRAM 24, where the start of the read-out operation is indicated by the RAM selection circuit 222, is alterable within a unit of one vertical scanning period. Consequently, the aforementioned switching during the display period is not conducted, and the image flickering can be prevented.

The DRAM address generation circuit 224 sequentially refreshes the read address based on the DRAM start address DSTAD, following the indication of the start of the read-out operation from the RAM selection circuit 222. The DRAM address generation circuit 224 generates a read address as well as a read-out request signal RDReq to the DRAM controller 32. The completion of the read-out operation is acknowledged to the DRAM address generation circuit 224 with an acknowledge signal RACK from the DRAM controller 32. In FIG. 8, the drawing of the control signal, in the case where the image data is written in to the DRAM 22, is omitted, while the DRAM address generation circuit 224 generates a write address and a write-in request signal WRReq. Then, the completion of the read-in operation is acknowledged to the DRAM address generation circuit 224 with an acknowledge signal WACK from the DRAM controller 32.

The SRAM address generation circuit 226 sequentially refreshes the read address based on the SRAM start address SSTAD, following the indication of the start of the read-out operation from the RAM selection circuit 222. The SRAM address generation circuit 226 generates a read address as well as a read-out request signal RDReq to the SRAM controller 34. The completion of the read-out operation is acknowledged to the SRAM address generation circuit 226 with an acknowledge signal RACK from the SRAM controller 34. In FIG. 8, the drawing of the control signal, in the case where the image data is written in to the SRAM 24, is omitted, while the SRAM address generation circuit 226 generates a write address and a write-in request signal WRReq. Then, the completion of the read-in operation is acknowledged to the SRAM address generation circuit 226 with an acknowledge signal WACK from the SRAM controller 34.

As described, in the memory selection register 228, a control information is set during the non-display period, in order to specify, from where among the DRAM 22 and the SRAM 24 (the first and the second memories), the image data is read out. Moreover, as described in FIGS. 4 and 5, the RAM data switching circuit 26 sequentially reads out the image data, from either one of the RAM that is in accordance with the set value of the RAM selection register 228, among the DRAM 22 or the SRAM 24 (for example, from the SRAM 24). Subsequently, it sequentially reads out the image data from the other RAM set in advance (for example, the DRAM 22), so as to display it in the display period of the image data's display area. Hence the mixed data is output.

The output of the selector 220 is provided to a FIFO (First-In First-Out) 230 that has a first-in first-out function. The image data accumulated in the FIFO 230 is sequentially read out by a FIFO read circuit 232, and is provided to the display driver 50.

The synchronization signal-generation circuit 38 includes a vertical counter 240 and a horizontal counter 242.

The vertical counter 240 counts the pulses of horizontal synchronization signals HSYNC generated by the horizontal counter 242, and outputs the vertical synchronization signal VSYNC that remains at level H until the counted value thereof matches the vertical line information from the control register 42. Further, the vertical counter 240 generates the read-start request, provided at the time before a certain period based on this pulse, where that period is in accordance with the access timings of the DRAM 22 or the SRAM 24.

The horizontal counter 242 counts the dot clock (pixel clock) pulses DCLK generated by the pixel clock generation circuit 250, and outputs the horizontal synchronization signal HSYNC that remains at level H until the counted value thereof matches the horizontal pixel width information from the control register 42.

The pixel clock generation circuit 250 outputs the dot clock DCLK, by which the given base clock is divided. The RGB-format image data for each pixel that is output to the display driver 50 is output in synchronization with the dot clock DCLK.

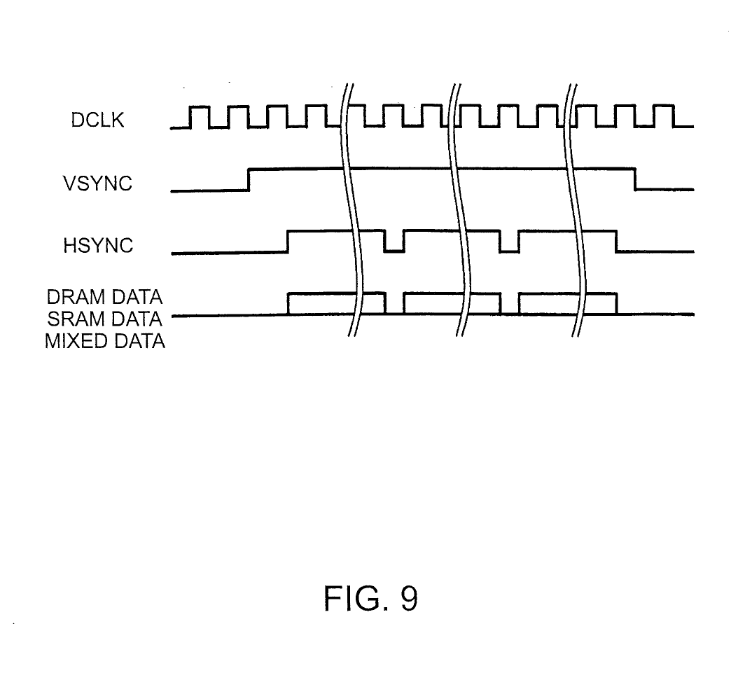

The LCD I/F circuit 36 in FIG. 2 may include the RAM data switching circuit 26, the FIFO 230, the FIFO read circuit 232, the synchronization signal-generation circuit 39, and the pixel clock generation circuit 250 in FIG. 8. As shown in FIG. 9, the LCD I/F circuit 36 outputs the synchronization signals (a vertical synchronization signal VSYNC, a horizontal synchronization signal HSYNC, and a dot clock DCLK) to the display driver for the display panel 60 to display, along with the DRAM data, SRAM data and the mixed data that is read out from the DRAM 22 and SRAM 24.

Hereafter, the description for the DRAM controller 32 as well as the SRAM controller 34 in FIGS. 2 or 8, whereto the address and the like from the DRAM address generation circuit 224 and the SRAM address generation circuit 226 are provided, is explained.

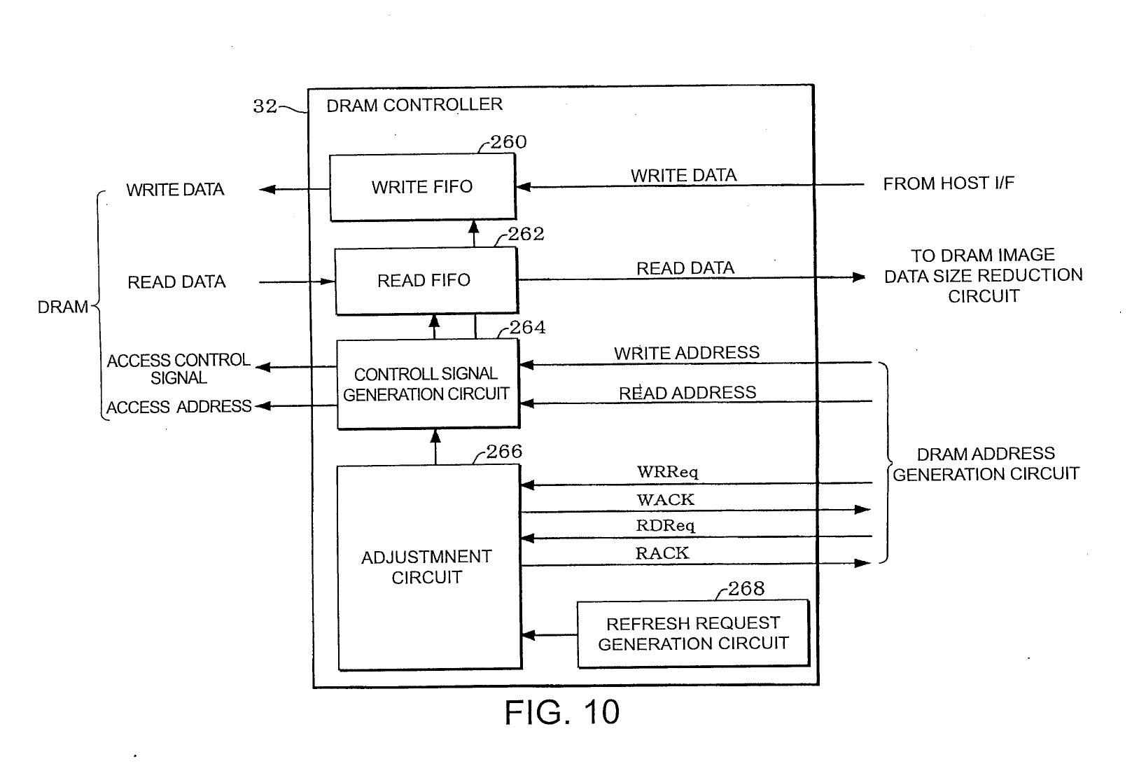

In FIG. 10, an example structure of the DRAM controller 32 in FIG. 2 or FIG. 8 is shown.

The DRAM controller 32 includes a write FIFO 260, a read FIFO 262, a control signal generation circuit 264, an adjustment circuit 266, and a refresh request generation circuit 268.

The write FIFO 260 builds up the image data from the host via the host I/F circuit 30, and sequentially outputs the write data to the DRAM 22 on the timing indicated by the control signal generation circuit 264. The read FIFO 262 accumulates the read data from the DRAM 22, and sequentially outputs the read data to the DRAM data image size reduction circuit 200 (or the image size reduction circuit 40) on the timing indicated by the control signal generation circuit 264.

The control signal generation circuit 264 generates the control signals and the addresses for the write-in operation to, or the read-out operation from, the DRAM 22, based on the write address or the read address from the DRAM address generation circuit 224, and on the adjustment result of the adjustment circuit 266.

The adjustment circuit 266 adjusts between the requests, such as the write-in and read-out requests from the DRAM address generation circuit 224, and the refresh request from the request generation circuit 268. The result thereof is notified to the control signal generation circuit 264, and the completion of the access that corresponds to the request signal is acknowledged with the acknowledge signals WACK and RACK.

The refresh request generation circuit 268 generates refresh requests to the adjustment circuit 266 in accordance with refresh cycle of the DRAM 22.

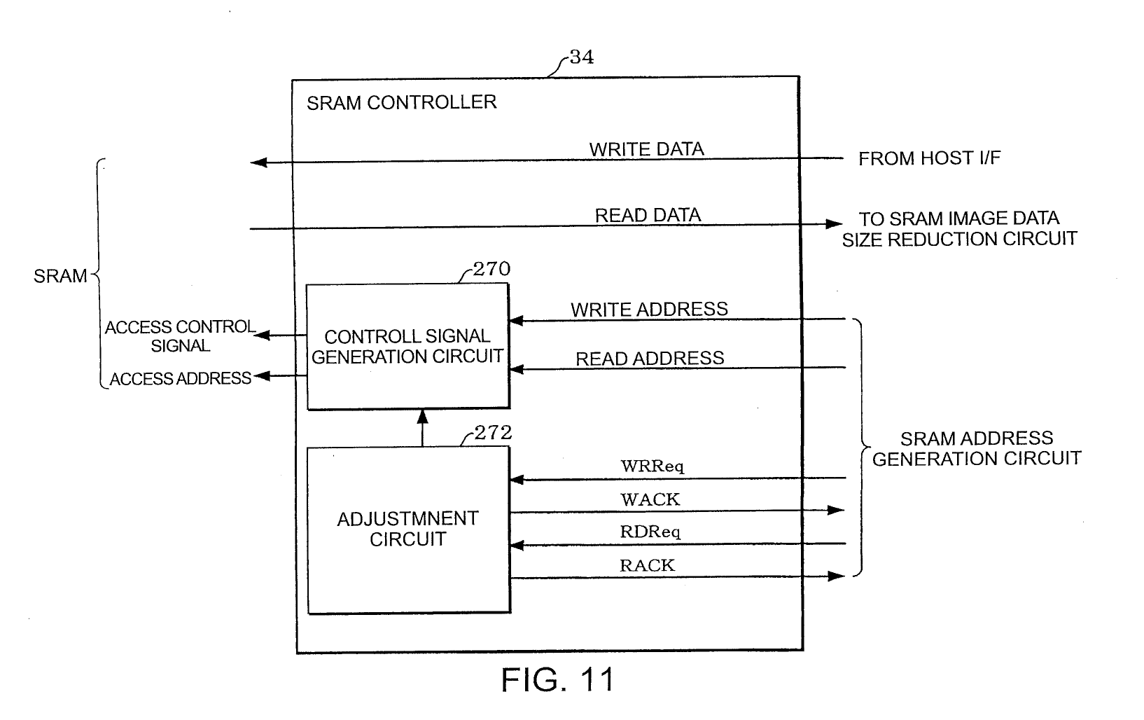

In FIG. 11, an example structure of the SRAM controller 34 in FIG. 2 or FIG. 8 is shown.

The SRAM controller 34 includes a control generation circuit 270 and an adjustment circuit 272.

The control signal generation circuit 270 generates the control signals and the addresses for the write-in operation to, or the read-out operation from, the SRAM 24, based on the write address or the read address from the SRAM address generation circuit 226, and on the adjustment result of the adjustment circuit 272.

The adjustment circuit 272 adjusts the requests between the write-in request and the read-out request from the SRAM address generation circuit 226. The result thereof is notified to the control signal generation circuit 270, and the completion of the access that corresponds to the request signal is acknowledged with the acknowledge signals WACK and RACK.

The image data read out from the DRAM 22 and the SRAM 24 by the DRAM controller 32 and the SRAM controller 34, is provided to the DRAM data image size reduction circuit 200 and the SRAM data image size reduction circuit 210. The DRAM data image size reduction circuit 200 and the SRAM data image size reduction circuit 210 have an identical structure, hence an example structure of the DRAM data image size reduction circuit 200 is explained hereafter.

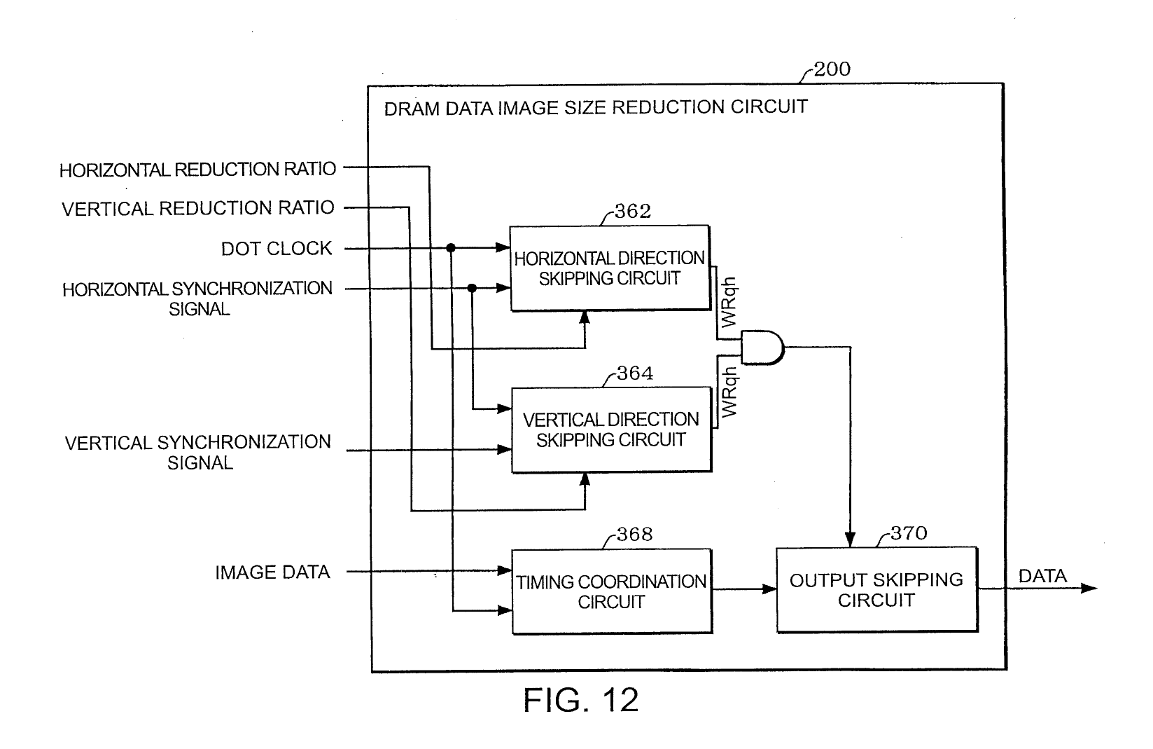

In FIG. 12, an example structure of the DRAM data image size reduction circuit 200 is shown.

A horizontal reduction ratio and a vertical reduction ratio, set as the DRAM data size information DSIZE, is input to the DRAM data image size reduction circuit 200. The horizontal reduction ratio is a reduction ratio of the image in the horizontal direction, and has a decimal value, which is larger than 0 and smaller than or equal to 1. The vertical reduction ratio is a reduction ratio of the image in the vertical direction, and has a decimal value, which is larger than 0 and smaller than or equal to 1.

The DRAM data image size reduction circuit 200 generates the image data, whose size is reduced horizontally by skipping pixels aligned in the horizontal direction according to the horizontal reduction ratio. The DRAM data image size reduction circuit 200 generates the image data, whose size is reduced vertically by skipping pixels aligned in the vertical direction according to the vertical reduction ratio.

This DRAM data image size reduction circuit 200 includes a horizontal direction skipping circuit 362, a vertical direction skipping circuit 364, a timing coordination circuit 368, and an output skipping circuit 370. Besides the horizontal reduction ratio and the vertical reduction ratio, the image data read-out from the dot clock DCLK, the vertical synchronization signal VSYNC, the horizontal synchronization signal HSYNC, and the DRAM 22, are input to the DRAM data image size reduction circuit 200. The vertical synchronization signal VSYNC regulates one vertical scanning period. The horizontal synchronization signal HSYNC regulates one horizontal scanning period. During one horizontal scanning period, the image data for each pixel is sequentially input to the DRAM data image size reduction circuit 200 in synchronization with the dot clock.

In FIG. 12, the horizontal direction skipping circuit 362 generates, during one horizontal scanning period regulated by the horizontal synchronization signal, a horizontal direction write request WRqh that remains at level H only during the period that is in accordance with the horizontal reduction ratio. Moreover, the vertical direction skipping circuit 364 generates, during one vertical scanning period regulated by the vertical synchronization signal, a vertical direction write request WRqv that remains at level H only during the period that is in accordance with the vertical reduction ratio. A skipping control signal provided to the output skipping circuit 370 is generated with a logic operation AND of the horizontal direction write request WRqh and the vertical direction write request WRqv.

The timing coordination circuit 368 is structured with a data latch. The timing coordination circuit 368 latches the image data in synchronization with the dot clock DCLK, and outputs the timing coordinated data to the skipping circuit 370.

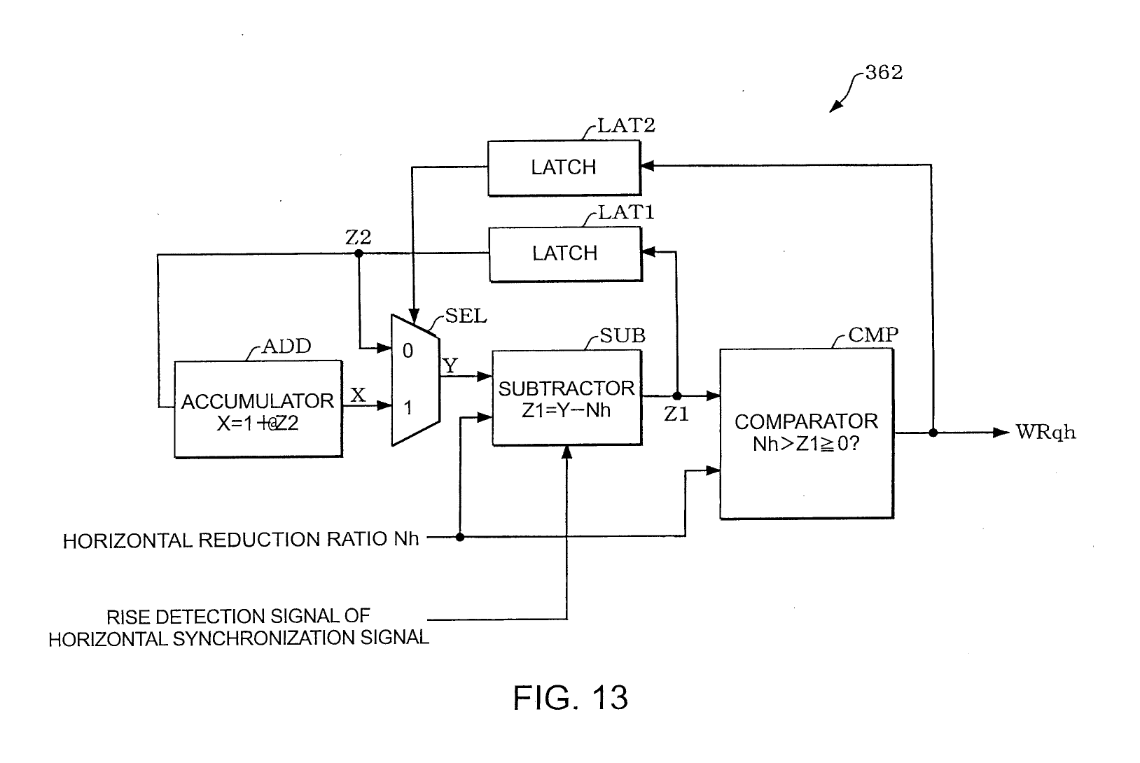

In FIG. 13, a block diagram of an example structure of the horizontal direction skipping circuit 362 is shown.

Each part of the horizontal direction skipping circuit 362 operates in synchronization with the dot clock DCLK.

A subtracter SUB subtracts a horizontal reduction ratio Nh from an input Y, and outputs an output Z1 determined thereby as a decimal value. The subtracter SUB initializes the output Z1 to 0 in synchronization with the rise detection signal.

A latch LAT1 latches the output Z1 of the subtracter SUB. The output of the latch LAT1 is output to a selector SEL as well as to an accumulator ADD.

The accumulator ADD accumulates 1 to the output Z2 of the latch LAT1, and outputs an output X determined thereby as a decimal value. The output X of the accumulator ADD is output to the selector SEL.

A comparator CMP compares the output Z1 of the subtracter SUB and the horizontal reduction ratio Nh. More specifically, the comparator CMP sets the horizontal direction write request WRqh at level H, if the horizontal reduction ratio Nh is smaller than the output Z1 of the subtracter SUM and the output Z1 of the subtracter is at least 0. Otherwise, it sets the horizontal direction write request WRqh at level L.

The output of the comparator CMP is provided to a latch LAT2. The output of the latch LAT2 serves as a switching control signal of the selector SEL. The selector SEL outputs the output X of the accumulator ADD if the output of the latch LAT2 is 1 (level H), and it outputs the output Z2 of the latch LAT1 if the output of the latch LAT2 is 0 (level L).

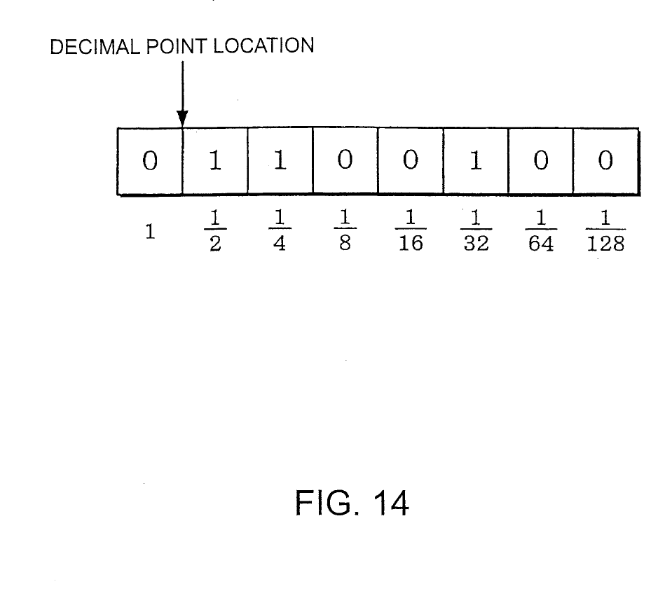

In FIG. 14, an explanatory drawing of the horizontal reduction ratio Nh is shown.

If the granularity of the horizontal direction skipping circuit 362 is set to 8 bits, the horizontal reduction ratio Nh expresses the most significant bit (MSB) as integer data, and the rest as a floating point data. For example, if the horizontal reduction ratio Nh is set to 1, it is expressed as “10000000”.

Hereafter, an example of the operation of the horizontal direction skipping circuit 362 shown in FIG. 13 is explained, where the horizontal reduction ratio Nh is 0.781. When the horizontal reduction ratio Nh is set to 0.781, the approximation thereof is expressed as 0.781=½+¼+ 1/32, or “01100100” in 8 bit data.

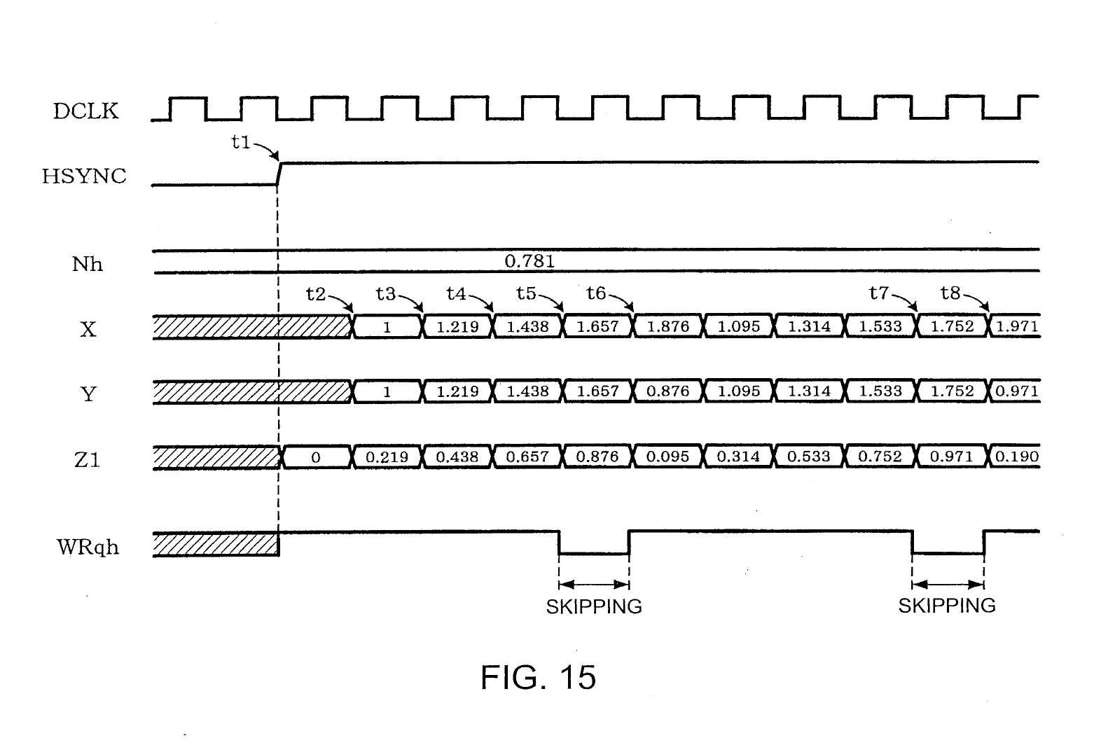

In FIG. 15, the timing chart of an example of the operation of the horizontal direction skipping circuit 362 in FIG. 13, is shown.

When the horizontal synchronization signal HSYNC changes from level L to level H at time t1, the output Z1 of the subtracter SUB is initialized to 0. Here, the horizontal reduction ratio Nh (=0.781) is larger than the output Z1 (=0) of the subtracter SUB, thus the output WRqh of the comparator CMP is determined to be 1 (level H).

At the next fall time t2 of the next dot clock, the output of the latch LAT2 is 1 (level H). Here, the latch LAT1 takes in the output Z1 of the subtracter SUB and outputs it as the output Z2. The output X of the accumulator ADD is 1. The output of the latch LAT2 is 1, thus the output Y of the selector SEL is selected to be the output X (=1) of the accumulator ADD. Therefore, the output Z1 of the subtracter SUB is 0.219 (=1−0.781). Here, the horizontal reduction ratio Nh (=0.781) is larger than the output Z1, thus the output WRqh of the comparator CMP remains 1 (level H).

Similarly, after a fall time t3 of the next dot clock, the output X of the accumulator ADD is 1.219, and the output Z1 of the subtracter SUB is 0.438 (=1.219−0.781). Here, the horizontal reduction ratio Nh (=0.781) is larger than the output Z1, thus the output WRqh of the comparator CMP stays as 1 (level H).

Further, after a fall time t4 of the next dot clock, the output Z1 of the subtracter SUB is 0.657 (=1.438−0.781). Here, the horizontal reduction ratio Nh (=0.781) is larger than the output Z1, thus the output WRqh of the comparator CMP remains 1 (level H).

Finally, after a fall time t5 of the next dot clock, the output Z1 of the subtracter SUB is 0.876 (=1.657−0.781). Here, the horizontal reduction ratio Nh (=0.781) is smaller than the output Z1, thus the output WRqh of the comparator CMP changes to 0 (level L).

Then, after a fall time t6 of the next dot clock, the output of the latch LAT2 is 0 (level L). Here, the latch LAT1 takes in the output Z1 of the subtracter SUB and outputs it as the output Z2. The output X of the accumulator ADD is 1.876. Since the output of the latch LAT2 is 0, the output Y of the selector SEL is output as Z2 (=0.876) of the latch LAT1. Therefore, the output Z1 of the subtracter SUB is 0.095 (=0.876−0.781). Here, the horizontal reduction ratio Nh (=0.781) is larger than the output Z1, thus the output WRqh of the comparator CMP again changes to 1 (level H).

Similarly, the output WRqh of the comparator CMP changes to 0 (level L) at time t7, and to 1 (level H) at time t8.

As described, the output WRqh of the comparator CMP can be kept at level H during the period that is in accordance with the horizontal reduction ratio Nh (=0.781).

The structure and operation of the horizontal direction skipping circuit 362 are explained thus far. A similar description applies to the vertical direction skipping circuit 364 in FIG. 12. The only differences are that each part of the vertical direction skipping circuit 364 operates based on the horizontal synchronization signal HSYNC, that the subtracter is initialized at the rise of the vertical synchronization signal VSYNC, and that the vertical reduction ratio Nh is input. The description for the vertical direction skipping circuit 364 is omitted since it can be implemented in the same manner.

The image data of each pixel is sequentially provided to the DRAM data image size reduction circuit 200, in the order of the vertical direction of the image, advancing along the horizontal direction of the image thereof. In this case, the output skipping circuit 370 outputs only the image data, wherein the pixels thereof are provided when requests such as the horizontal direction write request WRqh and the vertical direction write request WRqv, generated in the aforementioned manner, are at level H.

As described above, the display controller 20 in the embodiment includes the large capacity DRAM 22. If the chip size grows as a result of the above, it is desirable to organize the display controller 20 with a semiconductor chip in three-dimensional packaging. In particular, a device commonly called “a stacked type semiconductor device” is desirable. In such device, the first semiconductor chip, in which the DRAM 22 is formed, and the second semiconductor chip, in which both the SRAM 24 and the RAM data switching circuit 26 are formed, are laminated.

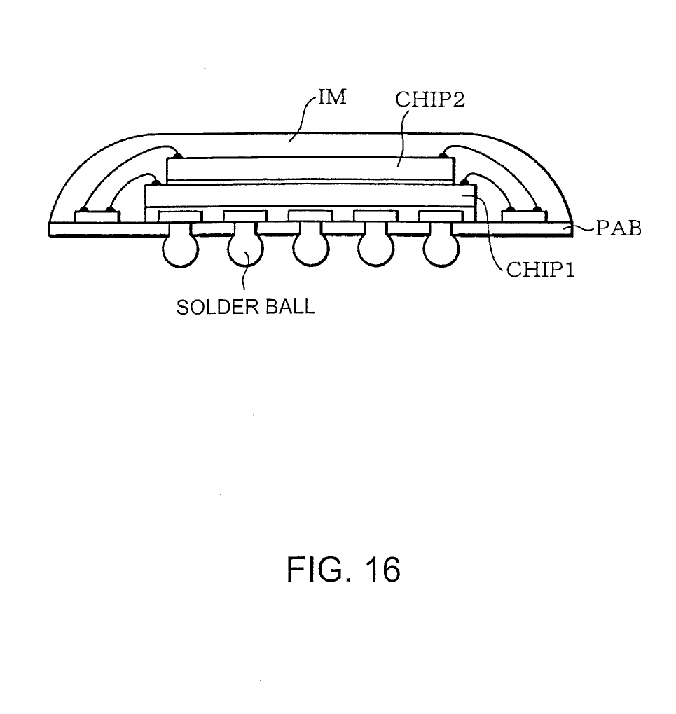

In FIG. 16, an example of the sectional structure of the display controller organized as a stacked type semiconductor device, is shown.

In the embodiment, the electrodes are installed on a package substrate PAB. The above electrode and the solder ball formed in the package substrate PAB as an external connection part, are electrically connected. On the package substrate PAB, the first semiconductor chip CHIP1, in which the DRAM 22 is formed, is installed via an insulation layer. On the first semiconductor chip CHIP1, the second semiconductor chip CHIP2, in which the SRAM 24 and the RAM data switching circuit 26 are formed, is installed via an insulation layer.

Electrodes are formed in the first and the second semiconductor chips CHIP1 and CHIP2, and are electrically connected to the electrodes formed on the package substrate PAB with a bonding wire. Then, the first and the second semiconductor chips CHIP1 and CHIP2 are sealed with a dielectric resin IM.

By employing such an embodiment, even a the display controller with the large capacity DRAM 22, can be packaged inside mobile appliances. Here, in terms of packaging, there is no disadvantage compared to a display controller with only a small-sized chip memory built into it. Rather, it is possible to gain the positive effects of mounting the large capacity DRAM 22.

Display System Operation Example

Hereafter, an operation example of the display system in FIG. 1 that includes the display controller in the embodiment is described.

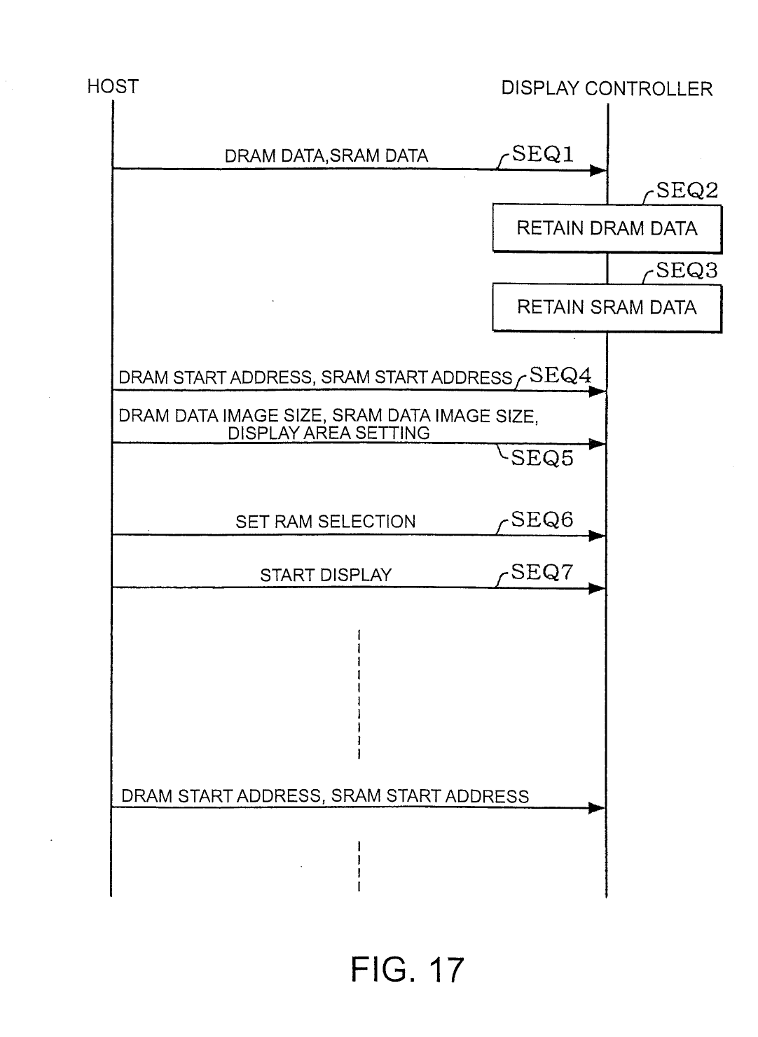

In FIG. 17, the sequence chart of an example of the operation of the display system in FIG. 1, is shown. An example of the sequence of the host 10 that accesses the display controller 20 is shown in FIG. 17.

First, the host 10 provides the image data (DRAM data), which is video data, to the DRAM 22 through the host I/F circuit 30 of the display controller 20 (SEQ1). In the display controller 20, the DRAM data is written in to the DRAM 22. As a result, multiple frames of video data are retained in the DRAM 22 (SEQ2).

Further, the host 10 provides the image data (SRAM data), which is a still image data, to the SRAM 24 through the host I/F circuit 30 of the display controller 20 (SEQ1). In the display controller 20, the SRAM data is written in to the SRAM 24. As a result, at least one frame of still image data is retained in the SRAM 24 (SEQ3).

Subsequently, the host 10 provides the DRAM start address and the SRAM start address of the RAM space, wherein the image data of the image to display is retained, to the display controller 20 (SEQ4). In the display controller 20, the control information is set to the control register 42 through the host I/F circuit 30.

Similarly, the host 10 provides to the display controller 20, a display area, the DRAM data image and the SRAM data image sizes that set the image size to display, and the display area setting information (SEQ5). In the display controller 20, these control information is set to the control register 42 through the host I/F circuit 30.

Further, the host 10 conducts the RAM selection setting for specifying either the DRAM data or the SRAM data for each display area (SEQ6), and then indicates a display start (SEQ7). The display start indication is executed by the access of the host 10 to the display start control register (not shown) in the control register 42.

Thereafter, the host 10 iterates SEQ 4 through SEQ 7.

As described, a display based on, for example, the mixed data shown in FIG. 4, can be conducted, in accordance with the setting of the host 10, with a diminished load for the host, as well as with low power consumption.

Electronic Appliance

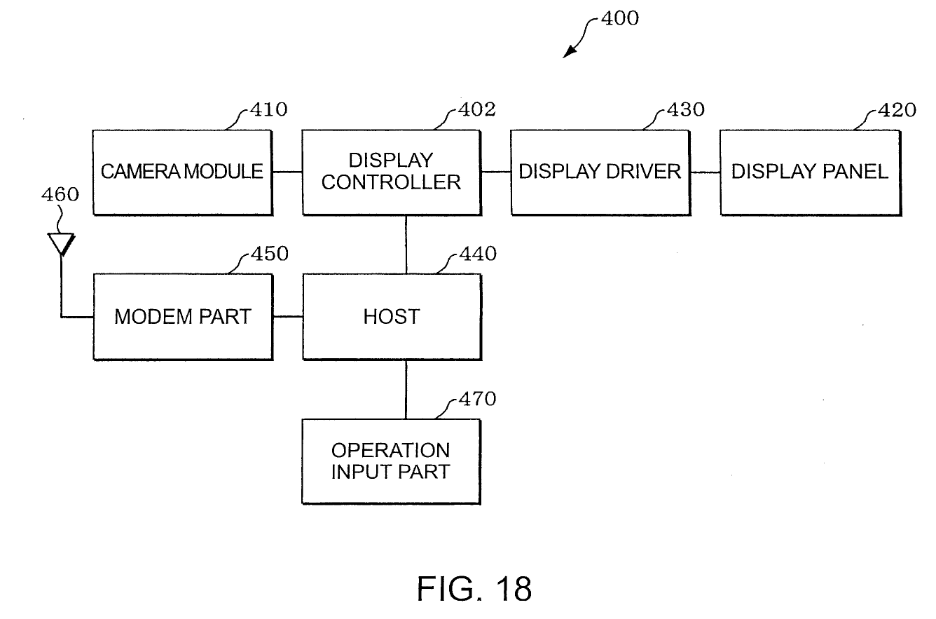

In FIG. 18, a block diagram of an example structure of an electronic appliance, wherein the display controller in the embodiment is applied, is shown. Here, an example structure for a mobile phone is shown in the block diagram as the electronic appliance.

A mobile phone 400 includes a camera module 410. The camera module 410 includes the CCD camera, and provides the data of the image photographed by the CCD camera to a display controller 402 in a YUV format. The display controller 20 in the embodiment may be employed as the display controller 402.

The mobile phone 400 includes a display panel 420. A liquid display panel may be employed as the display controller 420. In this case, the display panel 420 is driven by a display driver 430. The display panel 420 includes multiple scanning lines, multiple data lines, and multiple pixels. The display driver 430 functions as a scan driver that selects the scanning line, either one or several lines out of the multiple scanning lines at a time, and as a data driver that provides the corresponding voltage of the image data to the multiple data lines.

The display controller 402 is connected to the display driver 430, and provides the image data in RGB format to the display driver 430.

The host 440 is connected to the display controller 402. The host 440 controls the display controller 402. Further, the host 440 can demodulate the image data received through an antenna 460 in a modem part 450, and can subsequently provide it to the display controller 402. The display controller 402 displays the image on the display panel 420 with the display driver 430, based on this image data.

The host 440 can modulate the image data generated by the camera module 410 in the modem part 450, and can subsequently command the transmission to another communication device through the antenna 460.

The host conducts the transmitting or receiving processes of the image data, the imaging at the camera module 410, and the display process of the display panel, based on the operational information from an operation input part 470.

In FIG. 18, the liquid crystal display panel is used as an example in the explanation of the display panel 420. However, the embodiment shall not be limited to this structure. The display panel 420 may be an electroluminescence, or a plasma display device, and it can be applied to the display controller that provides the image data to the display driver that drives those devices.

The present invention shall not be limited to the embodiments mentioned above, and within the main scope of the present invention, it is possible to embody the present invention with other kinds of modifications.

For example, in FIG. 8, it is explained that one kind of image data is read out from either the DRAM 22 or the SRAM 24, where the image data for each display area is specified from the total of two kinds of data. However, it is also possible to read out several kinds of image data from either one or both of the DRAM 22 and the SRAM 24, where the total of 3 kinds or more of the image data is specified for each display area. Here, it is desirable that at least 2 kinds of image data are read out from the DRAM 22. This can be attained by adding another circuit similar to that of the DRAM address generation circuit.

In accordance with the dependent claims of the invention, it is also possible to omit some parts of the requirements of the claims of which the dependent claims are subordinates. Moreover, the main scope of the first aspect of the invention can be a subordinated of another aspect of the invention.

What is claimed is:

1. A display controller comprising:
a first memory that stores first image data; and
a second memory having a storage capacity smaller than a storage capacity of the first memory, the second memory storing second image data.

2. The display controller according to claim 1, further comprising:
a display displaying images that are based on data including at least a part of the first image data and at least a part of the second image data.

3. The display controller according to claim 1,
the first image data including multiple frames of first images, and
the second image data including at least one frame of second images.

4. The display controller according to claim 1,
the first image data including a plurality of images, and
the second image data including one image.

5. The display controller according to claim 1,
the first image data including a video image, and
the second image data including a still image.

6. The display controller according to claim 1, further comprising:
a first memory controller that controls operation of the first memory; and
a second memory controller that controls operation of the second memory.

7. The display controller according to claim 1,
the first memory being a Dynamic Random Access Memory (DRAM); and
the second memory being a Static Random Access Memory (SRAM).

8. An electronic appliance comprising:
a display panel; and
the display controller according to claim 1.
